(19) United States
(12) Patent Application Publication
(10) Pub. No.: US 2025/0223228 A1
(43) Pub. Date: Jul. 10, 2025

(54) CEMENTITIOUS MIXTURE AND USE THEREOF

(71) Applicant: RESTONE AS, Stavanger (NO)

(72) Inventors: Jill Angelique CLAUSEN, Fyllingsdalen (NO); Eyvind TIME, Bryne (NO)

(21) Appl. No.: 18/847,914

(22) PCT Filed: Jul. 17, 2023
(86) PCT No.: PCT/NO2023/060020

§ 371 Date: Sep. 17, 2024

(30) Foreign Application Priority Data
Jul. 19, 2022 (NO) 20220808

(51) Int. Cl. C04B 28/00; C04B 22/06; C04B 40/00; C04B 111/60

(52) U.S. Cl. CPC C04B 28/008; C04B 22/062; C04B 40/0039; C04B 2111/60

(57) ABSTRACT

The present invention relates to a cementitious mixture comprising a magnesium-iron solid solution silicate filler or aggregate. a strong base. one or more cementitious materials: and at most 12% water. The present invention further relates to use of the cementitious mixture for making an aqueous slurry, and a method of making a cementitious slurry

### FIELD OF THE INVENTION

The present invention relates to a cementitious mixture, use of the cementitious mixture for making an aqueous slurry, and a method of making a cementitious slurry. In particular, the present invention relates to a method to activate a filler/aggregate in concrete using a base. The invention is suitable for strengthening absorbent concrete or cement-based screeds, based on cements.

Concrete is a hardened building material created by combining a chemically inert mineral aggregate, a binder (e.g. Portland cement, supplementary cementitious materials (SCM) like fly-ash, slag and reactive silica), and water. Cement that hardens when mixed with water, represents one of several components in modern concrete. As concrete dries, it acquires a stone-like consistency that renders it ideal for constructing roads, bridges, and other structures that comprise a substantial portion of the world's wealth.

According to the National Institute of Standards and Technology (NIST), building concrete facilities is one of the United States' largest industries and represents about 10 percent of the gross national product. Over $4 billion worth of hydraulic cement, a variety which hardens under water, is produced annually in the United States for use in $20 billion worth of concrete construction. The value of all cement-based structures in the United States is in the trillions of dollars but the cost of repairing those structures in the long term will very expensive.

US 2021163360 A1 discloses a cementitious mixture comprising cement and divalent magnesium-iron silicates having the capacity to be a latent hydraulic binder in neutral or basic aqueous solutions. This reference further discloses an interaction between a base and a magnesium-iron silicate, which interaction takes place in an aqueous environment.

This invention improves concrete durability by making a protective carbonated zone-sealing to avoid chemical corrosion to rebar in concrete. In addition, cracks or other deformation caused by mechanical and thermal stresses will be self-healed if the filler/aggregate is within the concrete mixture.

A process and method for activating a filler/aggregate in concrete by adding a base is described. As natural processes are a slow process in time of concrete, this invention will be an excellent solution to extend the lifetime of concrete. This increases the durability of the concrete and cause less maintenance cost over time.

For use indoors and outdoors, and in fresh and hardened concrete. This invention has application for carbon capture where carbonation of the magnesium-iron solid solution silicate is desirable. It also has applications where there is no carbon dioxide present. The application can be in the oil and gas industry, as well as in construction industries.

### SUMMARY OF THE INVENTION

One of the objects of the present invention is to provide a dry cementitious mixture in which a mixture with water will produce both water glass and magnesium hydroxide. Further, another object of the present invention is to provide a method by which a slurry can be made that does not involve a traditional separation step for water glass and magnesium hydroxide.

It is yet another object of the present invention to provide a process and method, that are suitable for industrial use, to activate a filler/aggregate in concrete by a base in a fresh and hardened concrete. The method disclosed is to activate a filler/aggregate in concrete that will occur if the filler and aggregates are within the concrete. The speed is dependent upon Blaine (grain surface size), temperature and chemistry.

In some aspects, the techniques described herein relate to a cementitious mixture comprising
(i) a magnesium-iron solid solution silicate filler or aggregate from an earth-based system;
(ii) a strong base;
(iii) one or more cementitious materials; and
(iv) at most 12% free water.

In some aspects, the techniques described herein relate to a mixture, wherein the amount of magnesium-iron solid solution silicate is between 2% and 40%, preferably between 5% and 30%, most preferably between 10% and 25% by weight of cementitious material.

In some aspects, the techniques described herein relate to a mixture, wherein the amount of strong base is less than 10%, preferably between 1% and 5%, and most preferably between 2% and 4% by total weight of the cementitious material.

In some aspects, the techniques described herein relate to a mixture, wherein the cementitious material is an alkaline cement.

In some aspects, the techniques described herein relate to a mixture, wherein the base is NaOH or KOH.

In some aspects, the techniques described herein relate to a mixture, wherein the magnesium-iron solid solution silicate is selected from the group of minerals consisting of olivines, orthopyroxenes, amphiboles, and serpentines.

In some aspects, the techniques described herein relate to a mixture, wherein the magnesium-iron solid solution silicate is from an earth based system. In some aspects, the techniques described herein relate to a mixture, wherein the cementitious material is an alkali cement, or alkaline cement.

In some aspects, the techniques described herein relate to a method of making a cementitious slurry comprising the steps of:
(i) reacting an earth-based magnesium-iron solid solution silicate filler or aggregate with a strong base to produce a mixture of magnesium hydroxide, CaO—SiO₂—H₂O gel, water glass based on the strong base, and mixtures thereof; and
(ii) adding the products of step (i) to a slurry of one or more cementitious materials and water without first separating the water glass based on the strong base.

In some aspects, the techniques described herein relate to a method of making a slurry including the steps of:
(i) reacting an earth-based magnesium-iron solid solution silicate filler with KOH or NaOH to produce a mixture of magnesium hydroxide, CaO—SiO2-H2O gel, sodium or potassium based water glass or mixtures thereof;
(ii) adding the products of step (i) to a slurry of one or more cementitious materials and water without separation of the sodium or potassium based water glass first; wherein the KOH and/or NaOH is a regenerated reactant.

In some aspects, the techniques described herein relate to a method, wherein the amount of magnesium-iron solid solution silicate is between 2% and 40%, preferably between 5% and 30%, most preferably between 10% and 25% by weight of cementitious material.

In some aspects, the techniques described herein relate to a method, wherein the amount of sodium or potassium based water glass is between 1% and 10% by total weight of the of cementitious material.

In some aspects, the techniques described herein relate to a method, wherein the amount of strong base is less than 10%, preferably between 1% and 5%, and most preferably between 2% and 4% by weight of cementitious material.

In some aspects, the techniques described herein relate to a method, wherein step (i) produces more Mg²⁺ than SiO4⁴⁻.

In some aspects, the techniques described herein relate to a method, wherein the magnesium-iron solid solution silicate is from an earth-based system and is selected from the group of minerals consisting of olivines, orthopyroxenes, amphiboles, and serpentines.

In some aspects, the techniques described herein relate to a method, further including a step (iii) pouring the slurry of step (ii) and allowing it to cure, wherein the temperature of the curing is between 0° C. and 30° C.

In some aspects, the techniques described herein relate to a method, wherein the cementitious material is an alkaline cement.

In some aspects, the techniques described herein relate to the use of a cementitious mixture as disclosed herein for making an aqueous slurry.

In some aspects, the techniques described herein relate to a process of making a cementitious slurry comprising adding water to the cementitious mixture as disclosed herein.

These and other objects and aspects of the invention will be described in further detail hereinafter.

### DEFINITIONS AND REACTIONS

### Magnesium-Iron Solid Solution Silicates

The term “divalent magnesium-iron solid solution silicates” is a term of the art in geological and mineralogical sciences. A common short-hand term in the art is “magnesium-iron silicates”. In natural earth-based systems, there are more magnesium ions than iron ions present.

Magnesium-iron silicates have variable compositions due to “solid-solution” chemistry mainly involving Mg²⁺ and Fe²⁺ ions. These are silicate systems where iron and magnesium ions can occupy the same place in the mineral. This is called substitution and can occur over the complete range of possible compositions because iron and magnesium have a similar atomic radius (Fe⁺²=0.78 Å and Mg⁺²=0.72 Å) and can have the same valence state.

As an example, the formula for olivine is often given as: (Mg,Fe)₂SiO₄. To one skilled in the art, olivine can be thought of as a mixture of Mg₂SiO₄ (forsterite—Fo) and Fe₂SiO₄ (fayalite—Fa). If there is more forsterite than fayalite (thus more magnesium than iron), it can be referred to as a magnesium-iron silicate. If there is more fayalite than forsterite, then it can be referred to as an iron-magnesium silicate.

As another example, the formula for orthopyroxene is often given as: (Mg,Fe)₂Si₂O₆. To one skilled in the art, olivine can be thought of as a mixture of Mg₂Si₂O₆ (Enstatite—En) and Fe₂Si₂O₆ (Ferrosilite). Orthopyroxenes always have some Mg present in nature and pure ferrosilite is only made artificially. Orthopyroxene with more Mg than Fe is referred to as a magnesium-iron silicate. If there is more ferrosilite than enstatite, then it can be referred to as an iron-magnesium silicate.

### Fillers

Fillers are materials whose function in concrete is based mainly on size and shape. They may interact with cement in several ways; to improve particle packing and give the fresh concrete other properties, and even to reduce the amount of cement in concrete without loss of strength. Ideally, fillers partially replace cement and at the same time improve the properties and the microstructure of the concrete. Common fillers include quartz, limestone, and other non-alkali-reactive aggregates. Replacement of cement by a filler will often lead to a more economical product and improved the properties of the cured concrete.

It is known that filler type and content have significant effect on fresh concrete properties where non-pozzolanic fillers improve segregation and bleeding resistance. Generally, filler type and content may have a significant effect on unit weight, water absorption and voids ratio. In addition, non-pozzolanic fillers may have an insignificant negative effect on concrete compressive strength.

As currently defined in NS-EN 12620 is filler the aggregate with grains less than 2 mm. Filler may have a grain size where most of the grains pass 0.063 mm sieve. Fillers may be added to concrete in building materials to give certain properties. Filler may be the finest grain fraction in aggregates for concrete and mortar. The fraction with a grain diameter below 0.125 mm is usually called filler sand.

If the filler content becomes too large, the water demand may increase, and reduced firmness and increased shrinkage can be the result.

### Serpentine Reactions

Soapstone (also known as steatite or soaprock) is a type of metamorphic rock. It is composed largely of the magnesium rich mineral talc with varying amount of micas, chlorite, amphiboles, carbonates and other minerals. It may be produced by dynamothermal metamorphism and metasomatism by heat and pressure without melting and with influx of fluids. Talc may be seen as a weathering product from magnesium-iron silicates:

Olivine→serpentine→soapstone (talc and steatite)

Formation of serpentine minerals from magnesium-iron silicates as olivine are well understood.

Magnesium-iron silicate minerals may react with water to metamorphose minerals. Exposed to water below 700° C., olivine will be hydrated. As the hydrated minerals have lower density, they have larger volumes.

Olivine is a solid solution of forsterite, the magnesium endmember of (Mg²⁺, Fe²⁺)₂SiO₄, and fayalite, the iron endmember, with forsterite typically making up about 90% of the olivine in ultramafic rocks.

Serpentinite can form from olivine via several reactions with water as a hydration product from olivine. The following are two typical reactions. The first is forsterite, silicon dioxide, and water to produce serpentine and the second is the reaction of forsterite and water to produce serpentine and brucite:

3Mg₂SiO₄+SiO₂+4H₂O→2Mg₃Si₂O₅(OH)₄ (1)

2Mg₂SiO₄+3H₂O→Mg₃Si₂O₅(OH)₄+Mg(OH)₂ (2)

Reaction 1 tightly binds silica, lowering its chemical activity to the lowest values seen in common rocks of the Earth's crust. Serpentinization then continues through the hydration of olivine to serpentine and brucite (Reaction 2).

Brucite (Mg(OH)₂) is formed during serpentinization of olivine rocks and when periclase (MgO) is hydrated. Weathering of dunite gives iddingsite (MgO·Fe₂O₃·3SiO₂·4H₂O) that is bright ochre in colour. The mixture of brucite and serpentine formed by Reaction 2 has the lowest silica activity in the serpentinite.

Serpentine group of minerals belongx to the phyllosilicates (sheet silicates) with the general composition Mg₆[Si₄O₁₀](OH)₈. The minerals of the serpentine group
Amesite Mg₂Al(AlSi)O₅(OH)₄
Antigorite Mg₃Si₂O₅(OH)₄
Lizardite Mg₃Si₂O₅(OH)₄
Chrysotile Mg₃Si₂O₅(OH)₄
Greenalite (Fe²⁺, Fe³⁺)₂₋₃Si₂O₅(OH)₄

A similar suite of reactions involves pyroxene-group minerals. Below are reactions of Enstatite and water both with and without silicon dioxide. In reaction 3, talc is produced. In reaction 4, talc and serpentine are produced:

3MgSiO₃+SiO₂+4H₂O→Mg₃Si₄O₁₀(OH)₂ (3)

6MgSiO₃+4H₂O→Mg₃Si₄O₁₀(OH)₂+Mg₃Si₂O₅(OH)₄ (4)

Reaction 3 quickly comes to a halt as silica becomes unavailable, and Reaction 4 takes over. When olivine is abundant, silica activity drops low enough that talc begins to react with olivine requiring higher temperatures than those at which brucite forms (Reaction 5):

Mg₂SiO₄+Mg₃Si₄O₁₀(OH)₂+9H₂O→5Mg₃Si₂O₅(OH)₄ (5)

Ultramafic rocks containing calcium-rich pyroxene (diopside), breaks down according to the reaction:

3CaMgSi₂O₆+6H⁺→Mg₃Si₂O₅(OH)₄+3Ca²⁺H₂O+4SiO₂ (6)

This raises the pH, often to very high values, and the calcium content of the fluids involved in serpentinization. These fluids are highly reactive and may transport calcium and other elements into surrounding mafic rocks.

Magnesium-iron silicate minerals reacts with acidic water, e.g. CO₂ in water (carbonic acid) to metamorphose minerals. Carbonation is when a mineral is exposed to CO₂. The new minerals have lower densities and higher volume.

Carbonation of serpentine forms talc (Mg₃Si₄O₁₀(OH)₂) with magnesite. Carbonation of olivine in the presence of water and carbon dioxide at elevated pressures and temperatures (300-450° C.) forms magnesite. Magnesite forms also when magnesium rich lizardite serpentine mineral reacts with CO₂:

2Mg₃Si₂O₅(OH)₄+3CO₂→Mg₃Si₄O₁₀(OH)₂+3MgCO₃+3H₂O (7)

### Dry Mixture

In chemistry the term “dry” can be difficult to formulate. On one end of the scale is anhydrous (no water) and on the other end is a slurry (enough water to make the mixture a liquid). Another concern when dealing with a magnesium-iron solid solution silicate is the fact that water can be trapped within the crystal matrix. These trapped water molecules will be referred to as “bound” while those that are simply the water surrounding the outside of the crystal structure are “free”. “Dry” unless specified will refer to a free water content of 12% or less.

### Strong Base

A strong base completely dissociates and ionizes 100% in an aqueous solution. Moreover, strong bases are good proton acceptors, which cannot remain in aqueous solution. Some strong bases are: LiOH (lithium hydroxide), NaOH (sodium hydroxide), KOH (potassium hydroxide), Ca(OH)₂ (calcium hydroxide), RbOH (rubidium hydroxide), Sr(OH)₂ (strontium hydroxide), CsOH (cesium hydroxide), Ba(OH)₂ (barium hydroxide).

### Reactive Silica and Water Glass Production

Reactive silica as processed from magnesium-iron silicates is well known using an acid. The magnesium and the reactive silica are also separated in the process having different scope of use. The reactive silica is then reacted (normally with NaOH or KOH) to produce “water glass” (i.e., alkali silicate). In the claimed method or process, a base is used, and there may be no separation of magnesium and reactive silica or water glass. Additionally, the activated magnesium-iron silicate in cement may be triggered.

It is possible to obtain amorphous, off-white, free-flowing silica with a typical specific surface area of 100 m²/g by leaching the basic mineral olivine, (Mg, Fe)₂SiO₄, with an acid and separating silica from lye, by filtering or decanting.

(Mg,Fe)₂Si0₄+4H⁺→Si(OH)₄+2(Mg,Fe)²⁺ (8)

Amorphous silica from olivine has a pozzolanic activity comparable to condensed silica fume from 4 days and continues thereafter. The compressive strength improvement after 2 and 28 days when ordinary Portland cement is replaced with silica is comparable to silica produced from Olivine and ordinary commercially available silicon vapor.

### DETAILED DESCRIPTION OF THE INVENTION

The present invention generally relates to a cementitious mixture comprising:
(i) a magnesium-iron solid solution silicate filler or aggregate
(ii) a strong base;
(iii) one or more cementitious materials; and
(iv) at most 12% free water.

Further, the present invention generally relates to a method of making a cementitious slurry comprising the steps of:
(i) reacting an earth-based magnesium-iron solid solution silicate filler or aggregate with a strong base to produce a mixture of magnesium hydroxide, CaO—SiO₂—H₂O gel, water glass based on the strong base, and mixtures thereof; and
(ii) adding the products of step (i) to a slurry of one or more cementitious materials and water without first separating the water glass based on the strong base.

According to the mixture and method of the invention, the amount of magnesium-iron solid solution silicate may be between 2% and 40%, preferably between 5% and 30%, most preferably between 10% and 25% by weight of cementitious material.

Further, according to the mixture and method of the invention, the amount of strong base may be less than 10%, preferably between 1% and 5%, and most preferably between 2% and 4% by total weight of the cementitious material. Preferably, the cementitious material is an alkaline cement. Preferably, the strong base is selected from LiOH (lithium hydroxide), NaOH (sodium hydroxide), KOH (potassium hydroxide), Ca(OH)₂ (calcium hydroxide), RbOH (rubidium hydroxide), Sr(OH)₂ (strontium hydroxide), CsOH (cesium hydroxide), Ba(OH)₂ (barium hydroxide), and mixtures thereof, preferably NaOH (sodium hydroxide) and/or KOH (potassium hydroxide), more preferably NaOH (sodium hydroxide).

According to the mixture and method of the invention, the magnesium-iron solid solution silicate may be selected from the group of minerals consisting of olivines, orthopyroxenes, amphiboles, and serpentines, preferably olivine. Preferably, the magnesium-iron solid solution silicate is from an earth based system.

The present invention also generally relates to the use of the cementitious mixture according to any the invention for making an aqueous slurry. Further, the present invention also relates to a process of making a cementitious slurry comprising adding water to a cementitious mixture according to the invention.

According to the method and process of the invention, the strong base may be a regenerated reactant.

According to the method of the invention, the amount of water glass based on the strong base may be between 1% and 10% by total weight of the of cementitious material. The water glass based on the strong base may be a water glass based on LiOH (lithium hydroxide), NaOH (sodium hydroxide), KOH (potassium hydroxide), Ca(OH)₂ (calcium hydroxide), RbOH (rubidium hydroxide), Sr(OH)₂ (strontium hydroxide), CsOH (cesium hydroxide), Ba(OH)₂ (barium hydroxide), and mixtures thereof, preferably NaOH (sodium hydroxide) and/or KOH (potassium hydroxide), or sodium and/or potassium-based water glass, more preferably NaOH (sodium hydroxide), or sodium-based water glass.

According to the method of the invention, the amount of strong base may be less than 10%, preferably between 1% and 5%, and most preferably between 2% and 4% by weight of cementitious material.

In the method of the invention, step (i) may produce more Mg²⁺ than SiO₄⁴⁻. The method of the invention may further comprise a step (iii) pouring the slurry of step (ii) and allowing it to cure. Preferably, the temperature of curing is between 0° C. and 30° C.

Note that this invention is not bound to the theory presented. Reaction of a magnesium-iron solid solution silicate and a strong base (normally NaOH or KOH) may lead to the production of water glass and magnesium hydroxide.

Olivine (Mg₂SiO₄), and other magnesium-iron silicates, can react with the alkalis (e.g., NaOH) in the pore water and form C—S—H gel (CaO—SiO₂—H₂O gel). This may be seen as the glue in concrete on the expanse of crystalline calcium hydroxide, Ca(OH)₂, being a major hydration product of Portland cement alongside C—S—H gel:

4NaOH(aq)+Mg₂SiO₄(s)→2Mg(OH)₂(s)+Na₄SiO₄ (aq) (9)

Na₄SiO₄(aq)+2Ca(OH)₂(s)+H₂O→2CaO—SiO₂—H₂O(s)+4NaOH(aq) (10)

In the reactions, (s) means that the compound is solid or precipitated and (aq) means that it is dissolved in water. Reaction 9 is written as if there was a total conversion of magnesium silicate, but in practice it will be a surface reaction eating inwards and it may be a two-step reaction going through serpentine on the way. This precipitates magnesium hydroxide and keeps sodium silicate (in the form of “water glass” in solution as Na₄SiO₂). In reaction 10, this “water glass” meets calcium hydroxide and precipitates C—S—H gel and releases sodium hydroxide back to solution so it can react with more magnesium silicate. In this way, sodium hydroxide is a regenerated reactant for the overall reaction.

Water glass, also known as sodium silicate or alkali silicate glass, is a glassy solid made up of sodium oxide (Na₂O) and silica (silicon dioxide, SiO₂) that has the benefit of being soluble in water. Commercially it is available as powders, rocks like forms, or liquid.

“Water glasses” can be based on sodium or potassium silicates, or mixes thereof, and their hydrolysis products. The general formula for water glass is given as (Na₂O)x·(SiO₂)y. The most common are those of sodium type water glasses (here formulated as Na₄SiO₄ (x=2, y=1), even though the molar ratio between Na2O and SiOz can vary from 1:2 to 3.75:1) or Na2SiO3 (x=1, y=1). When writing the chemical formula of a form of water glass, the oxygen molecules are added together. The invention will work with any of the water glasses that fit the general formula. Also note that the most common commercially available water glass is Na₂SiO₃ (sodium metasilicate).

Potassium-based water glass has the same formulas as sodium-based water glass where potassium replaces sodium. Depending on the pH of the solution, silicate ions in water glass have different degrees of polycondensation (forming polymers from different monomers).

When cement is mixed with water, the liquid phase of the paste becomes saturated with calcium ions, and the pH of the cement paste rises. Consequently, the introduction of water glass, which has a high alkaline activity, helps to increase the pH of the solution, and accelerate the cement hydration.

The introduction of water glass aids in making the C—S—H gel. Water glass reduces the setting time but is also good for sealing and forming a waterproof surface. However, too much water glass can result in concrete with poor long-term strength, but too little can keep the concrete from setting fast enough in various conditions.

Reacting the magnesium-iron silicate with a strong base produces water glass. By adjusting the amount of base used, the desired amount of water glass in each time frame and-rate can be produced without first separation, this results in a savings of time and resources.

In many situations, the addition of water glass can reduce the strength of the resultant concrete. However, different methods of introducing the water glass to the cement slurry results in different effects on the hydration process and final strength. Additionally, the self-healing properties of magnesium-iron solid solution silicates can result in a comparable or improved concrete strength when compared to concrete without water glass.

The addition of water glass to the cement through the reaction of the magnesium-iron solid solution silicate and a strong base is believed to lead to a higher degree of strength than other methods of adding the water glass separately.

The practical result of converting crystalline calcium hydroxide to amorphous C—S—H gel alongside precipitation of magnesium hydroxide, will be a densification of the pore structure and increased durability for such a blend. In this manner, it is possible to use a strong base as a regenerated reactant to activate a magnesium-iron solid solution silicate filler.

Some forms of magnesium-iron silicates have been used in the field of cementing. Normally this is as a binder. One effect of adding a magnesium-iron silicate to cement is that the resultant concrete can have self-healing properties to damage, can sequester carbon dioxide, and possibly reduce porosity to liquids and gas.

Another advantage of using NaOH is that it helps to protect the rebar. This is because of several factors. One is that it keeps the pH of the slurry higher for a longer period. Also, the reaction of serpentines and other magnesium-iron solid solution silicates with NaOH or KOH creates soapstone which may coat the rebar for additional protection.

A dry mixture of cementitious material, magnesium-iron solid solution silicate, in the form of a filler/aggregate, and a strong base. The amount of magnesium-iron solid solution silicate is between 2% and 40%, preferably between 5% and 30%, most preferably between 10% and 25% by weight of cementitious material.

The strong bases of KOH and NaOH are preferred because they produce the best water glass. The amount of strong base is between 0% (as some is inherent in the cement already) and 10%, preferably between 1% and 5%, and most preferably between 2% and 4% by weight of cementitious material.

The amount of sodium or potassium-based water glass mat be between 1% and 10% by total weight of the of cementitious material, depending on application. For example, if setting speed is a critical factor, a higher percentage (5% to 10%) may be considered.

While different types of cementitious material would work, alkaline cements (e.g. Portland cement) are preferred. It is preferred if the magnesium-iron solid solution silicate is olivines, orthopyroxenes, amphiboles, and/or serpentines, most preferably olivine. Natural earth-based systems are preferred to as they are in a more ready to use form when compared to non-natural systems.

A method of making a slurry using the base activated magnesium-iron silicate is to simply add the desired about of water to the dry mixture discussed above. Another way is to first react the magnesium-iron silicate with a base and then adding the result to a slurry of cementitious material and water (in one or more steps, or to the cementitious material first, or to the water first).

To take advantage of the positive properties of magnesium-iron silicates when added to cement, it is desirable that there is remaining magnesium-iron silicate in the slurry.

1. A cementitious mixture comprising:
(i). a magnesium-iron solid solution silicate filler or aggregate;
(ii). a strong base;
(iii). one or more cementitious materials; and
(iv). at most 12% free water, wherein the strong base is selected from NaOH (sodium hydroxide) and/or KOH (potassium hydroxide).

2. A method of making a cementitious slurry comprising the steps of:
(i) reacting an earth-based magnesium-iron solid solution silicate filler or aggregate with a strong base to produce a mixture of magnesium hydroxide, CaO—SiO₂—H₂O gel, and water glass based on the strong base; and
(ii) adding the products of step (i) to a slurry of one or more cementitious materials and water without first separating the water glass based on the strong base.

3. The mixture according to claim 1, wherein the amount of magnesium-iron solid solution silicate is between 2% and 40%, preferably between 5% and 30%, most preferably between 10% and 25% by weight of cementitious material.

4. The mixture according to claim 1, wherein the amount of strong base is less than 10%, preferably between 1% and 5%, and most preferably between 2% and 4% by total weight of the cementitious material.

5. The mixture according to claim 1, wherein the cementitious material is an alkaline cement.

6. The method according to claim 2, wherein the strong base is selected from LiOH (lithium hydroxide), NaOH (sodium hydroxide), KOH (potassium hydroxide), Ca(OH)₂ (calcium hydroxide), RbOH (rubidium hydroxide), Sr(OH)₂ (strontium hydroxide), CsOH (cesium hydroxide), Ba(OH)₂ (barium hydroxide), and mixtures thereof, preferably NaOH (sodium hydroxide) and/or KOH (potassium hydroxide).

7. The mixture according to claim 1, wherein the magnesium-iron solid solution silicate is selected from the group of minerals consisting of olivines, orthopyroxenes, amphiboles, and serpentines, preferably olivine.

8. The mixture according to claim 1, wherein the magnesium-iron solid solution silicate is from an earth based system.

9. Use of a cementitious mixture according to claim 1, for making an aqueous slurry.

10. A process of making a cementitious slurry comprising adding water to a cementitious mixture according to claim 1.

11. The method according to claim 2, wherein the strong base is a regenerated reactant.

12. The method according to claim 2, wherein the amount of water glass based on the strong base is between 1% and 10% by total weight of the of cementitious material.

13. The method according to claim 2, wherein the water glass based on the strong base is water glass based on LiOH (lithium hydroxide), NaOH (sodium hydroxide), KOH (potassium hydroxide), Ca(OH)₂ (calcium hydroxide), RbOH (rubidium hydroxide), Sr(OH)₂ (strontium hydroxide), CsOH (cesium hydroxide), Ba(OH)₂ (barium hydroxide), and mixtures thereof, preferably NaOH (sodium hydroxide) and/or KOH (potassium hydroxide), or sodium and/or potassium-based water glass, more preferably NaOH (sodium hydroxide), or sodium-based water glass.

14. The method according to claim 2, wherein step (i) produces more Mg²⁺ than SiO₄⁴⁻.

15. The method according to claim 2, further comprising a step (iii) pouring the slurry of step (ii) and allowing it to cure.

16. The method according to 15, wherein the temperature of the curing is between 0° C. and 30° C.

17. The mixture according to claim 1, wherein the strong base is NaOH (sodium hydroxide).

18. The method according to claim 2, wherein the amount of magnesium-iron solid solution silicate is between 2% and 40%, preferably between 5% and 30%, most preferably between 10% and 25% by weight of cementitious material.

19. The method according to claim 2, wherein the amount of strong base is less than 10%, preferably between 1% and 5%, and most preferably between 2% and 4% by total weight of the cementitious material.

20. The method according to claim 2, wherein the amount of strong base is less than 10%, preferably between 1% and 5%, and most preferably between 2% and 4% by total weight of the cementitious material.
